(19) United States
(12) Patent Application Publication
(10) Pub. No.: US 2011/0145393 A1
(43) Pub. Date: Jun. 16, 2011

(54) METHOD FOR DYNAMIC RESERVATION OF CLOUD AND ON PREMISES COMPUTING RESOURCES FOR SOFTWARE EXECUTION

(75) Inventors: Tami Ben-Zvi, Redmond, WA (US); Nir Ben-Zvi, Redmond, WA (US)

(73) Assignees: Tami Ben-Zvi, Redmond, WA (US); Nir Ben-Zvi, Redmond, WA (US)

(21) Appl. No.: 12/636,749

(22) Filed: Dec. 13, 2009

(51) Int. Cl. G06F 15/173

(52) U.S. Cl. 709/224; 709/226

(57) ABSTRACT

A method for dynamic reservation of cloud and on premises resources for software execution is disclosed. The method may be comprised of: receiving the specification for the resources needed for the software, evaluating the availability of resources and reserving the resources for the software. The method may include a protocol to discover, evaluate availability, negotiate terms and create a reservation contract for software execution resources based on the required specification. This can be implemented using resource agent modules that represent available software execution resources (e.g.: CPU, memory, storage, network . . . ) and reservation agent modules that are used for communicating with the resource agent modules for reserving software execution resources. In addition, monitoring agent modules are used to monitor the actual software execution reservation contract.

In another embodiment, a method for dynamic reservation of cloud and on premises resources for software execution may include a system for dynamic optimized reservation of software execution resources across cloud and on premises resources based on excess and demand which may include the above method with one or more contract aggregation modules that holds one or more reservation contracts for software execution resources and one or more re-negotiation reservation agent modules that continuously re-negotiates software reservation contracts based on up to date information. The contract aggregation module can also be a resource agent module representing reservation contracts that have not yet been fully fulfilled and thus can still be re-negotiated. The re-negotiation reservation agent module can re-negotiate a reservation contract for software execution resources that are required in the immediate timeframe or in the future. The re-negotiation reservation agent can use but is not limited to the following information when re negotiating software execution resources contracts: Software execution requirement, price, monitoring information, contract cancellation information, migration cost (in case the software is already running), scalability, security and compliance changes and availability of resources.

### BACKGROUND

As 2008 comes to an end, the software computing world is shifting with the introduction of Cloud computing where Amazon (EC2/S3/SimpleDB), Microsoft (Azure/Services platform) and others are offering fully managed software execution resources such as CPU, storage, network, message queues, database etc. as commodity resources to be purchased in various models such as pay per use and monthly fee. These Cloud resources are targeted to fit low end requirements as well as scale to serve high end requirements of full scale internet applications.

This opens up an obvious opportunity for startups to bootstrap their operation with low investment while being able to scale their application as their business grows.

On the other end this shift also opens up an opportunity for organizations of all sizes from the small business to the enterprise to optimize their software computing resources while increasing scale, availability, agility and other important aspects such as disaster recovery.

For example: say that a large company would like to launch a new service for consumers. The company starts off with provisioning a few servers in their data center for this service. No knowing whether the service would be very successful, the company does not want to invest capital in purchasing a large amount of computers and bandwidth in advance. Rather, the company can use cloud computing resources if the service becomes very popular.

Another example is where a company need a large amount of software execution resources on a regular cycle of seasonal peak time or for a specific one time calculation. These are cases where the availability of a scale of software execution resources for a given period of time can both allow the company to deliver on its business as well as save considerable cost.

Last, consider the opportunity for organizations to move from dealing with physical computer hardware in their server farms to using software execution resources for running some or all of their business's software. This allows organizations to have flexible and scalable yet affordable software execution resources while delivering to business needs such as manageability, security, compliance, availability and infrastructure resiliency to disasters

A prudent organization might tap into software execution resources from multiple Cloud computing providers as well as have its own server farm to optimize on total cost of ownership and deliver on critical business functionality.

One of the conclusions from the above is that software execution resources across Cloud and on premises, will become a commodity that can be reserved, sold and utilized through various business models where both Cloud computing resources and on premises resources play into the equations as well as other parameters such as scale, reliability, availability etc.

When regarding software execution resources as a commodity, we can further view that this is a highly dynamic commodity since software execution is dependent on a myriad of factors and it can exceed the expected resources, be delayed, migrated to execute on other resources or even cancelled. It is also a commodity with high versatility of specification ranging from CPU, memory, storage to security, compliance and availability.

As a commodity, the software execution resources can be reserved through contracts and re-sold or re-negotiated as the business parameters for these resources change

The use of the software execution resources commodity can also be monitored to provide dynamic re-assessment of the software execution resources so that resource reservation contracts can be dynamically re-negotiated and both the provider of the resources and the consumer of the resources can monitor the use of the commodity

Thus, there is a need for a method for dynamic reservation of cloud and on premises resources for software execution based on receiving the specification for the resources needed for the software, evaluating the availability of resources and reserving the resources for the software, followed by monitoring the usage of the software execution resources.

### SUMMARY

A method for dynamic reservation of cloud and on premises resources for software execution may include a protocol to discover, evaluate availability, negotiate terms and create a reservation contract for software execution resources based on the required specification

A method for dynamic reservation of cloud and on premises resources for software execution may further include resource agent modules that represent available software execution resources (e.g.: CPU, memory, storage, network . . . ) and reservation agent modules that are used for communicating with the resource agent modules for reserving software execution resources. In addition, monitoring agent modules are used to monitor the actual software execution reservation contract.

A method for dynamic reservation of cloud and on premises resources for software execution may be used to implement a system for dynamic optimized reservation of software execution resources across cloud and on premises resources based on excess and demand and on online monitoring and re-negotiation of the software execution resources usage and reservation contracts

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION

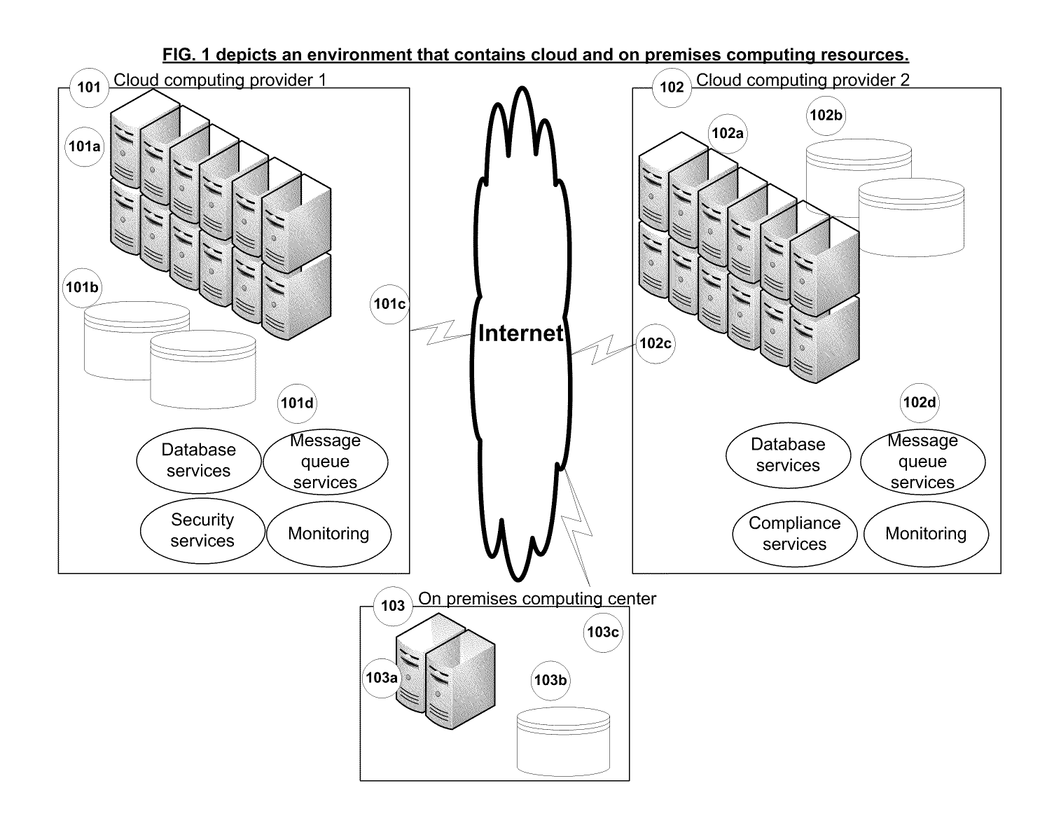

FIG. 1 depicts an environment that contains cloud and on premises computing resources.

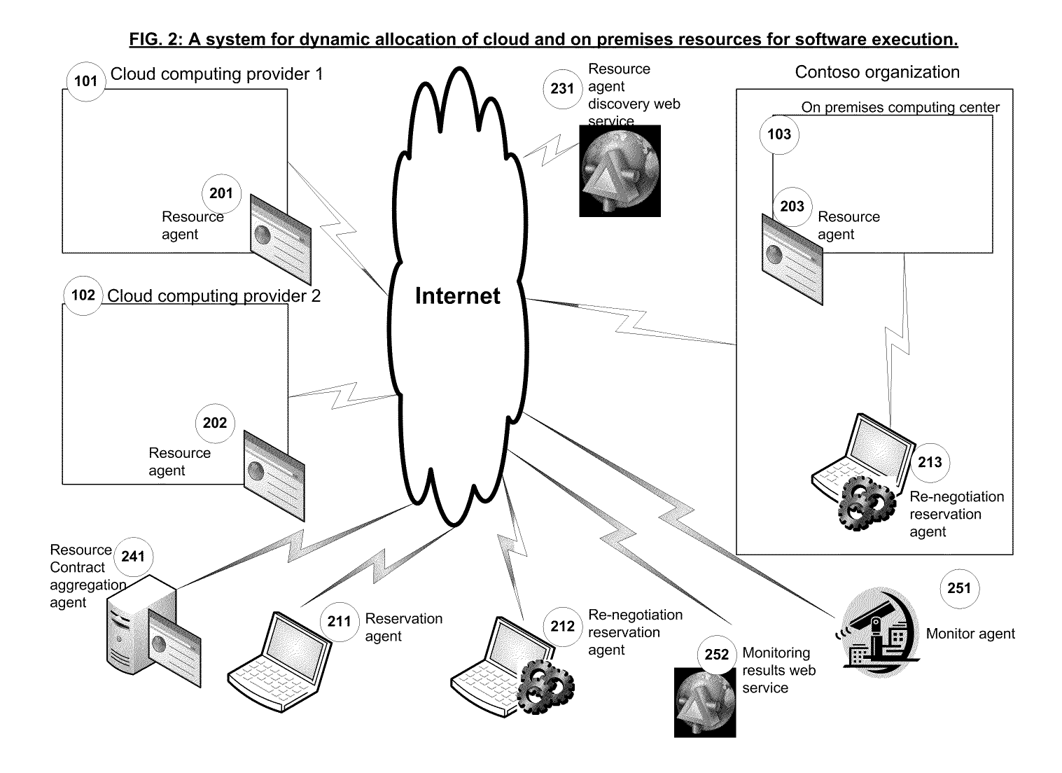

FIG. 2 depicts a system for dynamic reservation of cloud and on premises resources for software execution

### DETAILED DESCRIPTION

FIG. 1 depicts an exemplary environment of cloud computing providers and on premises computing resources. The environment includes an example of two cloud computing providers 101, 102 each offering various resources for software execution and one on premises computing center 103. The environment might include multiple cloud computing providers each providing a unique set of software execution resources and multiple on premises computing centers that are part an organization's infrastructure. Both cloud computing providers and on premises computing centers represent computing resources that can be used by one or more organizations. We will however maintain referencing each separately since these are clearly distinguishable in today's real environments.

In FIG. 1 exemplary environment, cloud computing provider 1-101 includes software execution resources such as computer sets 101a that provide CPU and memory resources, storage 101b that provides persistent storage for software executing in this environment, network resources 101c and an additional set of services 101d. Cloud computing provider 2-102 offers a similar set of resources and the on premises computing center —103 includes CPU/memory 103a, storage 103b and network 130c.

Software executing in this environment can be utilizing a combination of resources from one or more of the cloud providers 101, 102 and on premises computing center 103 resources. For example—software can use the CPU/memory resources on premises 103a along with storage from Cloud computing provider 1's storage 101b with networking resources from both on premises 103c and Cloud computing provider 101c for communication between the two. This is a valid scenario for software that requires highly available distributed shared storage across multiple on premises computing centers.

FIG. 2 depicts an exemplary system for dynamic reservation of cloud and on premises resources for software execution. The system includes the components of the exemplary environment described in FIG. 1 which include two cloud computing providers 101, 102 and one on premises computing environment 103 along with additional modules that comprise an exemplary system for the implementation of a system for dynamic reservation of cloud and on premises resources for software execution.

The resource agents 201, 202, 203 are used to represent the available computing resources and negotiate the reservation of the computing resources of the computing environments 101, 102 and 103 respectively.

In this implementation, each of the resource agents may represent all or a subset of the computing resources in its environment and has the ability to process a request to reserve computing resources, determine whether resources are available, negotiate the terms for the reservation and authorize the reservation of the resources for a specific or unlimited timeframe. In addition, the resource agent has the ability to limit the entities that have the ability to reserve computing resources. For example, in this system, resource agent 103 accepts only on-premises requests.

An exemplary request to reserve computing resources, may include: The timeframe for the reservation, range of hardware specification, scale specification for the various resources such as CPU, Network, Storage . . . , the availability, security, price, pricing model, indemnification, cancellation fee etc. . . .

The reservation agents 211, 212, 213 are used for reserving computing resources. These reservation agents communicate with the various resource agents (e.g.: resource agent 201, resource agent 202 . . . ) and negotiate resource reservation according to resource allocation requirements.

FIG. 2 shows three different exemplary instances of reservation agents. Reservation agent 211 does not have access to on premises resources and thus will make reservation with either cloud computing provider 1 (101) or cloud computing provider 2 (102).

Reservation agent 212 is a reservation agent with additional capabilities to re-negotiate reservations dynamically. This means that reservation agent 212 will make a reservation and continue to query the resource agents either on a schedule basis and/or when specific event occur in order to re-negotiate improved terms which could be price, availability and other services. When re-negotiating, the reservation agent will take into account the cost of “breaking” a reservation that was already made (since it is switching to a new reservation) and if the software is already executing on the current resources, the cost of switching (if any) to the new resources.

Reservation agent 213 is an on premises reservation agent which has the ability to reserve on-premises computing resources as well as cloud based computing resources. In this implementation, reservation agent 213 is not different than reservation agent 211, it just has access to additional resource agents (e.g.: resource agent 203). Reservation agent 213 is also a re-negotiating agent, thus as an example, in this implementation—when ample on premises computing resources become available, it might re-negotiate a reservation so that software running on a cloud computing environment can be moved to run on the available on premises resources.

In this implementation, the resource agents registers with a resource agent discovery web service 231 so that reservation agents can discover registered resource agents. As is obvious, there might be multiple web services to discover resource agents and these can be further federated. In addition, a reservation agent can have additional ways to discover resource agents such as DNS queries, multicast queries or a simple list provided to the reservation agent.

FIG. 2 also shows a resource contract aggregation agent 241. In this implementation the resource contract aggregation agent is an intermediate entity that federates resource contracts. This entity is used to trade in resources. The resource contract aggregation agent does not have to represent actual computing resources, instead, it accepts available resource contracts that are available to be reserved.

In this implementation, the resource contract aggregation agent includes three different distinct capabilities. The first capability is the ability to receive and maintain contracts of resources that are available to be reserved. Once a reservation is made for the available resources represented in the contracts that it maintains, the resource contract aggregation reports the reservation to the appropriate resource agent for the allocation of the actual computing resources.

The second capability is to present a resource agent interface to reservation agents so that reservation agents can reserve the available computing resources that are available in the contracts maintained by the resource contract aggregation agent. It can be observed that a resource contract aggregation agent can use different combinations of the computing resources available in the contracts it received to fulfill the request of the reservation agents

The third capability is to act as a reservation agent when a request for reserving computing resources is being made and there is no adequate available resource contract. The resource contract aggregation agent may then federate the request to another resource contract aggregation agent or to a resource agent to try and fill the requested reservation.

FIG. 2 also shows a monitor agent 251 and monitor web service 252. In this implementation, the monitor agent 251 is used to track the fulfillment of the computing resource reservation. There can be multiple monitoring agents running both within the computing centers as well as external to the computing centers. These monitoring agents may measure multiple variables ranging from the actual resources allocated to the availability, response time of the software and security aspects. This information is populated to one or more monitoring web services 252. The collection of information can then be correlated to the conditions of the computing resources reservation contract to make sure that the contract has been fulfilled or provide the criteria for appropriate compensation if the contract was not properly filled.

In addition, the monitoring information that is populated to web service 252 can be used by reservation agents when making resource reservation so that these reservation agents can take into account the reliability of the execution of the resource reservation contracts by the various computing environments

Last, in this implementation, the monitoring information populated to web service 252 can be used in real-time by re-negotiating reservation agents in a way that if a reservation contract is not being properly fulfilled, the re-negotiation reservation agent can reserve additional/other computing resources so that the appropriate computing resources will be immediately available for the executing software to meet its business requirements

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for dynamic reservation of resources for software execution comprised of: receiving the specification for the resources needed for the software, evaluating the availability of resources and reserving the resources for the software

2. The method of claim 1, wherein software execution resources are any resources required to execute software including but not limited to: CPU, memory, storage, network, database, message queues and power resources

3. The method of claim 1, wherein the software execution resources that will be considered are cloud computing resources or on premises resource or a combination of all

4. The method of claim 3, wherein the specification for the resources needed for the software include none or more of the basic resources needed for the software to run: The period for which the resources will be needed, CPU, memory, storage, network, database, message queues and special hardware devices and scaling requirements for each

5. The method of claim 3, wherein the specification for the resources needed for the software include additional high level requirements such as: Availability, security, responsiveness, compliance, disaster recovery and replication

6. The method of claim 3, wherein the specification for the resources needed for the software include pricing requirements such as: Price boundaries, cancellation fees and indemnification in case of failure to provide the resources

7. The method of claim 1, wherein the evaluation of availability is done by accessing multiple entities that own software execution resources to receive details on the available resources

8. The method of claim 1, wherein the evaluation of availability is done by accessing a central point that federates multiple software execution resources to receive details on the available resources

9. The method of claims 7 and 8, wherein the evaluation of availability is done by including entities that reserved software execution resources but did not yet utilize these resources or entities that broker reserved software execution resources

10. The method of claim 1, wherein the reservation of the software execution resources is done by accessing multiple entities that own software execution resources

11. The method of claim 1, wherein the reservation of the software execution resources is done by accessing a central point that federates multiple software execution resources

12. A system for dynamic reservation and brokering of software execution resources across cloud and on premises resources comprising:
a software execution resource reservation protocol to discover, evaluate availability, negotiate terms and create a reservation contract for software execution resources based on the required specification
one or more resource agent modules that represent software execution resources that can be reserved
one or more reservation agent modules that are used to reserve software execution resources
one or more monitoring agent modules that monitor the actual software execution reservation contract

13. The system of claim 12, wherein software execution resources are any resources required to execute software including but not limited to: CPU, memory, storage, network, database, message queues, special hardware and power resources.

14. The system of claim 12, wherein the specification for software execution resources include but not limited to: The time period, CPU, memory, storage, network, database, message queues, special hardware devices, scaling requirements, availability, security, responsiveness, compliance, disaster recovery, replication, price boundaries, timeline when the resources will be needed, cancellation fees and indemnification in case of failure to provide the resources

15. The system of claim 12, wherein a resource agent module represents one or more physical software execution resources

16. The system of claim 12, wherein a resource agent module represents one or more future reservation for software execution resources

17. The system of claim 15 and 16, wherein a resource agent module is manually operated, semi automated or fully automated

18. The system of claim 12, wherein a reservation agent module discovers resource agents, communicates the required specification and creates a contract for software execution resources for a specific timeframe (start time and length)

19. The system of claim 18, wherein a reservation agent module is manually operated, semi automated or fully automated

20. The system of claim 12, wherein a monitoring agent module monitors the execution of the reservation contracts to gather the current state of the software execution and track contract fulfillment

21. The system of claim 20, wherein the monitoring agent module is manually operated, semi automated or fully automated

22. The system of claim 20, wherein the information from multiple monitoring agent modules is collected and consolidated by a monitoring agent module

23. The system of claim 12, wherein the system is used for dynamic optimized reservation of software execution resources across cloud and on premises resources based on excess and demand further comprising:
one or more contract aggregation module that holds one or more reservation contracts for software execution resources.
one or more re-negotiation reservation agent module that continuously re-negotiates software reservation contracts based on up to date information

24. The system of claim 23, wherein the contract aggregation module is used by the resource agent modules to store existing contracts and provides information to all agent modules

25. The system of claim 23, wherein the contract aggregation module can also be a resource agent module representing reservation contracts that have not yet been fully fulfilled and thus can still be re-negotiated

26. The system of claim 23, wherein the re-negotiation reservation agent can use but is not limited to the following information when re negotiating software execution resources contracts: Software execution requirement, price, monitoring information, contract cancellation information, migration cost (in case the software is already running), scalability, security and compliance changes and availability of resources

27. The system of claim 23, wherein the re-negotiation reservation agent module can re-negotiate a reservation contract for software execution resources that are required in the immediate timeframe or in the future

28. The system of claim 23, wherein the re-negotiation reservation agent module can re-negotiate a reservation contract for currently running software so that it can be migrated to utilize software resources that better fit the software execution requirements

28. The system of claim 23, wherein the re-negotiation reservation agent module uses various prediction algorithms to pre-reserve software execution resources.
